(19) United States
(12) Patent Application Publication
(10) Pub. No.: US 2007/0174175 A1
(43) Pub. Date: Jul. 26, 2007

(54) Method for estimating the time position of queued electronic orders

(76) Inventor: Steven J. Brucato, Naperville, IL (US)

Correspondence Address: MICHAEL P. MAZZA, LLC, 686 CRESCENT BLVD., GLEN ELYN, IL, 60137, US

(21) Appl. No.: 11/336,201

(22) Filed: Jan. 21, 2006

(51) Int. Cl. G06Q 40/00

(52) U.S. Cl. 705/37

(57) ABSTRACT

A method and system for estimating and displaying the time position of queued electronic orders to market participants, whether the price and volume data for the orders is distributed by an electronic market using an aggregate volume distribution method or an order volume distribution method, by applying a worst case order queue position estimate.

The disclosures of concurrently-filed U.S. Ser. No. ______, titled “A Graphical User Interface And Method For Displaying Market Data And Entering Trading Orders,” concurrently-filed U.S. Ser. No. ______, titled “A Method For Indicating Current Market Prices Across A Range Of Prices,” concurrently-filed U.S. Ser. No. ______, titled “Optimized Order Routing For Electronic Trading,” U.S. Ser. No. ______, filed Dec. 6, 2005, titled “Method And System for Detecting And Managing Message Throttle Conditions,” U.S. Ser. No. ______, filed Dec. 21, 2005, titled “A Graphical User Interface And Method For Displaying Market Data And Entering Trading Orders,” and U.S. Pat. Nos. 6,938,011 and 6,772,132,” are hereby incorporated by reference into this application in their entirety.

### BACKGROUND OF THE INVENTION

The present invention generally relates to computerized trading systems. More specifically, the invention relates to a method for estimating the time position of queued electronic orders.

Trading of stocks, bonds, and derivatives (i.e., futures and options) has moved more and more into electronic trading. As market participants enter orders into these electronic markets, these orders are queued by the electronic market system. Multiple orders at the same price level, whether they represent an intent to buy or an intent to sell, may be submitted. In such cases where there are, for example, multiple buy orders for the same buy price, these orders are often queued in the order in which they were received. Electronic markets typically place the first order submitted (in terms of time) at the front of the queue, the next behind it, and so on. Most electronic markets which employ such queues do not reveal the order queue position to the trader. Because most electronic markets will automatically match buy and sell orders at the same price by their time position in queue, it would be advantageous for a trader to be able to determine or estimate the time position in queue for his/her orders.

### SUMMARY OF THE INVENTION

The present invention enables a trader to receive a real-time estimate of the time position of a buy or sell order in queue. The queue position may be updated as market buy or sell volumes, for a given price, are updated regardless of which market participant entered the orders.

In a preferred embodiment, a method is provided for estimating the time position of queued electronic orders traded on an electronic market which distributes price and volume orders using an aggregate volume distribution method. In this method, market participants enter buy and sell orders at the same price level into an electronic market. The orders are queued in the order in which they are received into order queue position. Price and volume data is distributed for the orders using an aggregate volume distribution method. The order queue position is revealed to the market participants, applying a worst case order queue position estimate for aggregate volume updates. Preferably, buy and sell orders are updated in real time, and the updated order queue position is displayed to the market participants.

In an alternative preferred embodiment, a method is provided for estimating the time position of queued electronic orders traded on an electronic market which distributes price and volume orders using an order volume distribution method. Market participants enter buy and sell orders at the same price level into an electronic market. The orders are queued in the order in which they are received. Price and volume data is distributed for the orders using an order volume distribution method. The order queue position is revealed to the market participants, applying a worst case order queue position estimate for order volume updates. Again, preferably, buy and sell orders are updated in real time, and the updated order queue position is displayed to the market participants.

In yet other alternative preferred embodiments, an electronic trading system is provided which allows market participants to place a trade order for a commodity traded on an electronic market which distributes price and volume data for the electronic orders using either an aggregate volume distribution method, or an order volume distribution method (the system may allow the trader or other user to pick which method is used, for example). A display, such as a computer monitor or other display, is provided to the trader or other user for displaying market depth of the commodity, and for displaying an order entry region aligned with a display of prices for the commodity. The order entry region includes areas for receiving commands to send trade orders, with each area corresponding to one of the prices for the commodity. A user input device is provided for a positioning a pointer over an area in the order entry region. The display(s) reveals the order queue position for the commodity to the market participants, and also reveals the distributed price and volume data for the orders using the applicable (aggregate or order) volume distribution method, and applying the applicable worst case order queue position estimate for (aggregate or order) volume updates. Preferably, the trade orders are updated in real time, and the display reveals the updated order queue position and updated distributed price and volume data for the updated orders.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a schematic diagram illustrating multiple market participants who may be connected to a single electronic market;

FIG. 2 consists of two schematic diagrams showing buy and sell orders, at the same buy price, queuing into a price level queue for that price;

FIG. 3 is a series of schematic diagrams showing the matching of orders at the same price, using a matching “price-time” algorithm;

FIG. 4 is a series of schematic diagrams illustrating a sequence referred to as a “worst case order queue position” estimate based on aggregate volume updates;

FIG. 5 is a series of schematic diagrams illustrating a sequence referred to as a “worst case order queue position” estimate based on order volume updates; and

FIG. 6 is an example of a Market Map™ displaying the order queue for each price level with real-time updates as volume/trade messages are received from the market.

The components in the drawings are not necessarily to scale, emphasis instead being placed upon clearly illustrating the principles of the present invention. In the drawings, like reference numerals designate corresponding parts throughout the several views.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

An “aggregate volume distribution method” means that an electronic market distributes price and volume data for electronic orders by revealing to market participants updates to the aggregate volumes for new orders at each price level.

“Order queue position” means the position of active buy and/or sell orders in the electronic market at the same price level.

An “order volume distribution method” means that an electronic market distributes price and volume data for electronic orders by revealing to market participants the incremental change to the volume for each new order at each price level.

“Worst case order queue position estimate for aggregate volume updates” means that an aggregate volume distribution method has been employed by the electronic market, that a new order is positioned at the rear-most position of the order queue position, that all previous orders in the market exist as a series of orders each equal to the maximum order size (as allowed by the market for the particular commodity) and/or a sub-maximum order quantity until the sum of all such order quantities equals the total quantity in the market and all these orders exist ahead of the newly entered order, that any subsequent increase in volume is assumed due to a single order of size equal to the incremental volume and causing the new order to move forward one position in the queue, and that any subsequent decrease in volume is assumed due to a single order of size equal to the incremental volume and reducing the quantity in the front-most order(s), successively, until the full quantity has been reduced.

“Worst case order queue position estimate for order volume updates” means that an order volume distribution method has been employed by the electronic market, that a new order is positioned at the rear-most position of the order queue position, that all previous orders in the market exist as a single order ahead of the newly entered order, that any subsequent increase in volume is assumed due to a single order of size equal to the incremental volume change and positioned at the rear of the queue, that any subsequent decrease in volume is assume due to a single order of size equal to the incremental volume change and removed from the front-most order(s) in the queue, in succession as necessary until the full quantity adjustment is made, and that if a trade message is received, quantity is received from the front-most order(s) in the queue, in succession as necessary until the full quantity adjustment is made.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

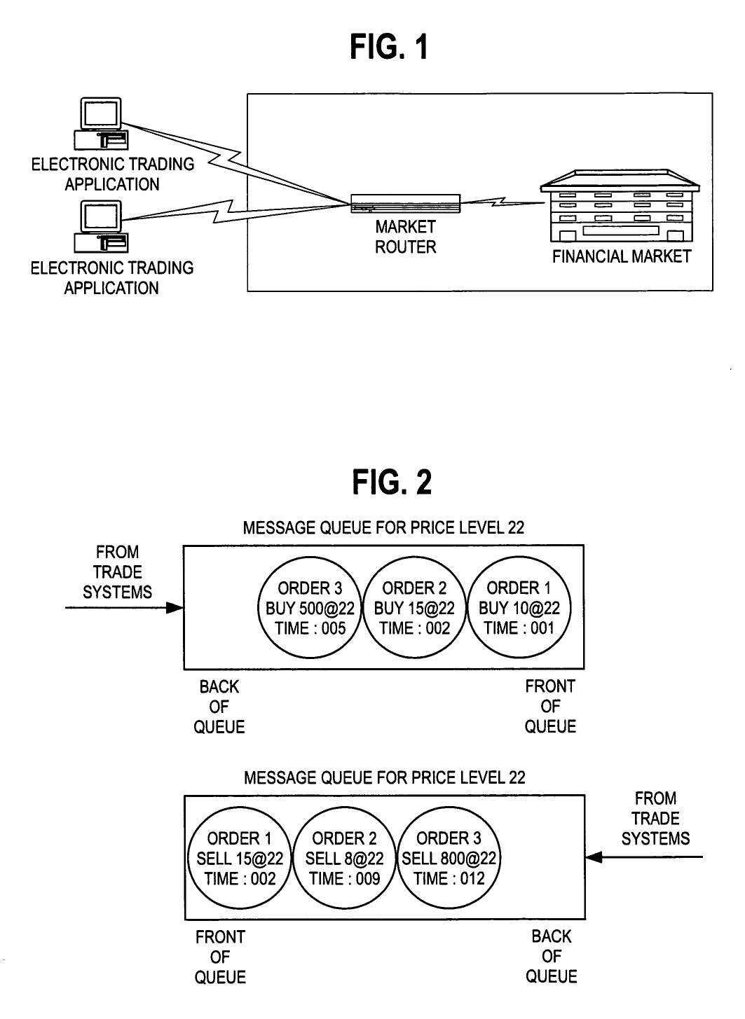

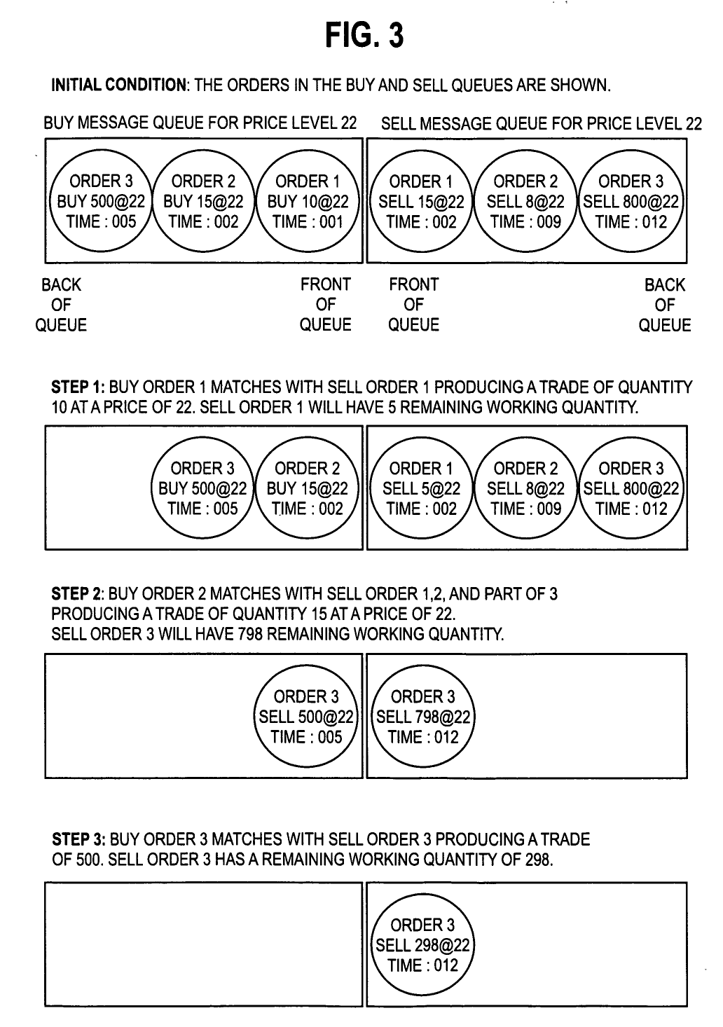

A brief background may be helpful. Multiple market participants may connect to a single electronic market, as shown in FIG. 1. (Of course, they may connect to multiple electronic markets, as well.) Referring to FIG. 2, electronic market software programs typically arrange trades such that the first order received goes to the front of the queue, the second order goes behind it, and so on. FIG. 3 is an example of the matching of orders at the same price. In this particular example, orders may be matched using a matching algorithm of “price-time,” meaning that any opposing orders (buy and sells) at the same price level are matched in order of their time position in queue.

As many electronic markets use time queuing and time priority as a function of matching, it is valuable for a trader to know the actual or estimated position of his orders in queue. For most electronic markets, a trader will not have access to the content of this queue. Instead, most electronic markets only show the aggregate volume at a price level. Taking the example in FIG. 3, this results in the following information being available to a trader: Buy 500@22, Sell 825@22. In other words, the trader sees only the total volume at each price level, not the individual orders in the buy and sell queues. It can be valuable for the trader to know the position of his order in the time queue. For example, if a trader knows that the trade behavior for a specific traded instrument is such that after a small volume trades, a large quantity is typically cancelled at that price level, then it is valuable for a trader to see that the first orders in queue on the sell queue are small orders. It is possible that as soon as these trade, the trader who has the large quantity order (e.g., 800@22 in Step 1 of FIG. 3) will be canceled.

How Price/Volume Data is Distributed

Aggregate Volume Distribution

Most electronic markets distribute price and volume data in two different formats. In some markets, only updates to the aggregate quantity are sent for each price level. There is no indication of how many orders constituted that change, or who entered those orders. Likewise, there is no indication as to whether the change in volume was due to a new order, a deleted order, a changed order, or a trade. The following example illustrates a time series of aggregate volume updates:

| Bid Volume | Bid Price | Ask Price | Ask Volume | Time Stamp |
|---|---|---|---|---|
| 100 | 2025 | 2050 | 200 | 0.001 |
| 101 | 2025 | 2050 | 200 | 0.002 |
| 101 | 2025 | 2050 | 220 | 0.005 |
| 81 | 2025 | 2050 | 318 | 0.010 |

Order Volume Distribution

The other popular format is to distribute market volume as individual orders. As individual orders are submitted to the market, the incremental change to the volume is distributed. For example, for each new order, the incremental volume (equal to the volume of the order) is distributed to all traders. Likewise, if an order is deleted, or changed, or if a trade occurs, the incremental decrease to the volume is distributed. The following example illustrates a time series of order volume updates:

| Vol Update | | | | | |
|---|---|---|---|---|---|
| Stamp | Bid Volume | Bid Price | Ask Price | Ask Volume | Time |
| None | 100 | 2025 | 2050 | 200 | 0.001 |
| Buy 1 | 101 | 2025 | 2050 | 200 | 0.002 |
| Sell 20 | 101 | 2025 | 2050 | 220 | 0.005 |
| Trade 9@bid | 92 | 2025 | 2050 | 220 | 0.010 |
| Trade | 81 | 2025 | 2050 | 220 | 0.010 |
| 11@bid | | | | | |

The difference between this time series and that shown in the aggregate volume time series is that the incremental change to volume, even if there are multiple incremental changes at the same or nearly the same time stamps, is distributed to the electronic traders. Thus, in the last two rows of this example, there are two messages received: one that is a trade at 2025 that decreases the aggregate bid amount by 9, and another trade that occurs at 2025 that further decreases the bid amount by another 11. If this occurred as aggregate volume updates, there would have been a single message update showing a change to the aggregate of 20.
Worst-Case Estimate of Order Time Position in Queue

The following algorithms describe how to estimate the worst-case (rear-most) position of an order in a time queue. The process varies based on whether the electronic market distributes aggregate or order volume updates.

Aggregate Volume Updates

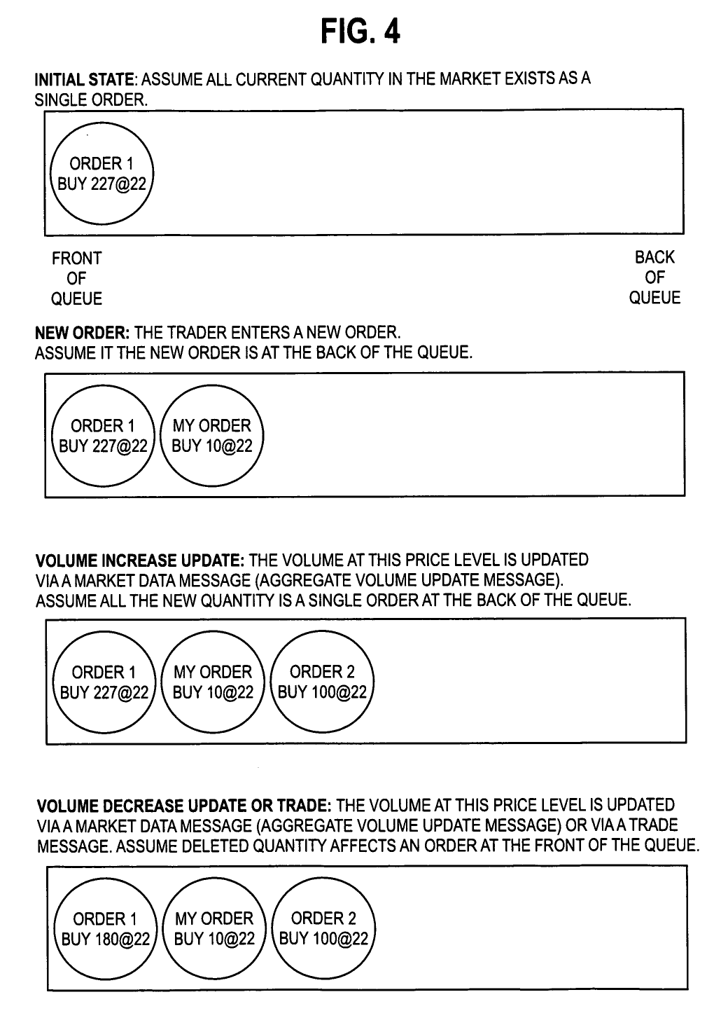

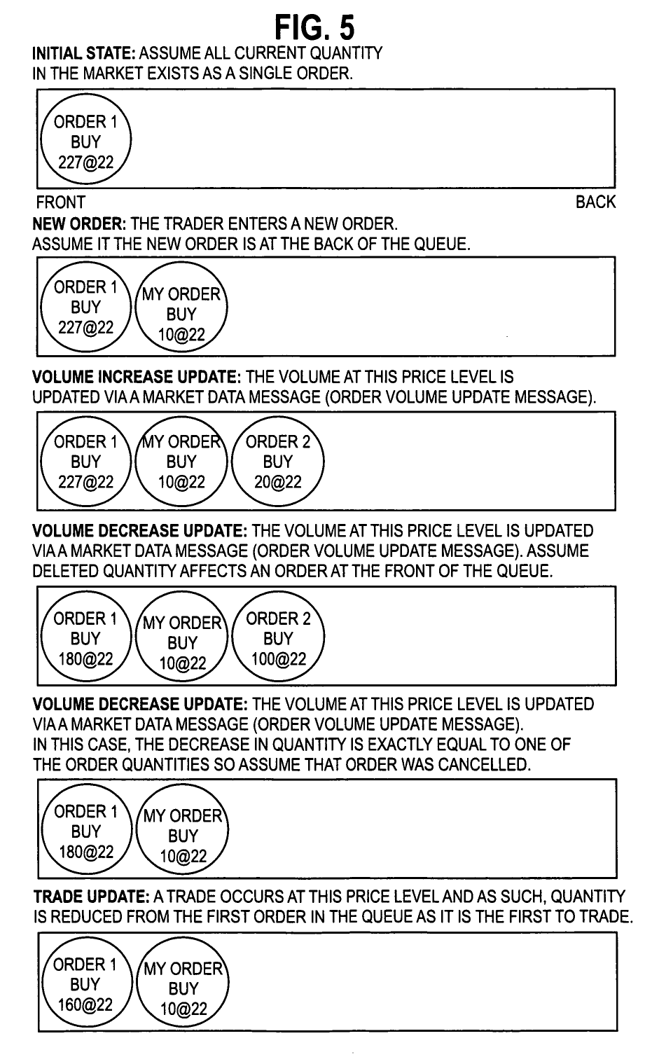

As soon as a trader enters a new order, it is assumed that the order is at the rear-most position of the queue and that all previous quantities in the market exist as a single order ahead of the newly-entered order. As soon as there is an increase in volume, it is assumed that the increase is due to a single order of size equal to the incremental volume. The trader's order then moves up one position in the queue. When a volume decrease message or trade message is received, the quantity in the front-most order is reduced or deleted, and the next-in-queue quantity is successively reduced or deleted; this process continues until the full quantity is reduced. The sequence shown in FIG. 4 illustrates this algorithm, which may be referred to as a “worst case order queue position” estimate based on aggregate volume updates.

Order Volume Updates

The process for estimating an order in queue position is slightly different when an electronic market distributes individual order volume updates. As soon as a trader enters a new order, it is assumed that the order is at the rear-most position of the queue and that all previous quantities in the market exist as a single order ahead of the newly-entered order. When a volume increase message is received, it is known to be from a single order so this is added as a new order to the back/rear of the queue. This is repeated for each new volume (new order) update: new orders are added to the back of the queue. When a volume decrease occurs (i.e., not due to a trade, but due to a canceled or revised quantity), then the quantity is removed from the front-most order in the queue. If the front order does not have sufficient quantity to account for the entire volume decrease message, then the next order in queue is reduced in quantity or deleted, and this process continues, as necessary, until the full quantity adjustment is made. However, if the volume decrease is exactly equal to the quantity of one of the orders in queue, that order is deleted. If a trade (e.g., volume decrease) message is received, quantity is removed from the front-most order in the queue. If this order does not have sufficient quantity, then quantities from following orders are reduced or orders are deleted; again, this process continues, as needed, to complete the trade quantity. The sequence shown in FIG. 5 illustrates this algorithm, which may be referred to as a “worst case order queue position” estimate based on order volume updates.

Complete Trading Day Information for Order Volume Updates

If the worst-case queue position estimation algorithm is used for order volume type markets, and this algorithm is used from the very beginning of the trading day, then it is not necessary to make the initial assumption that the initial order quantity present at a price level is incorporated into a single order. Because individual order volume adjustments are received as discrete messages, it is possible for this algorithm to estimate individual orders in the queue, but only if the algorithm starts with data received from the very start of the trading day.

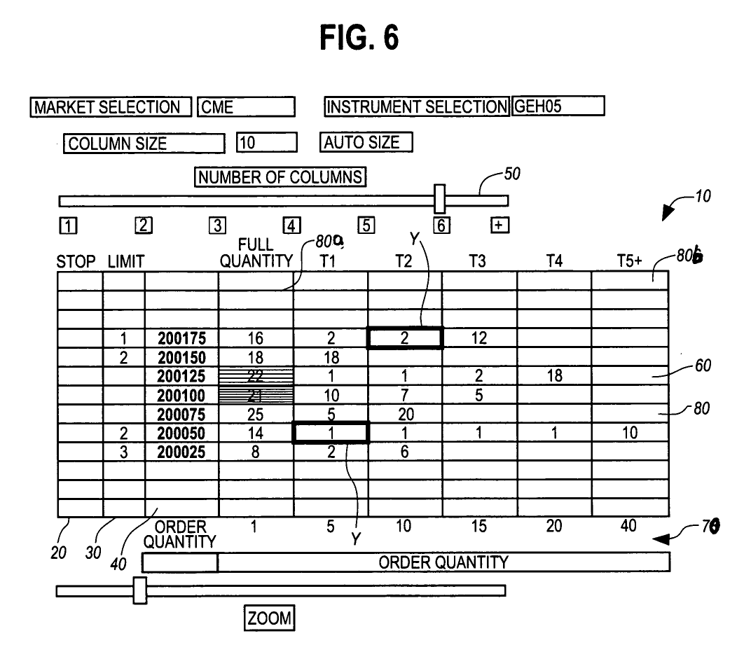

Display To The Trader In the preferred embodiment, the order queue for each price level (i.e. for full market depth) may be displayed to the trader with real-time updates as volume/trade messages are received from the market. FIG. 6 is an example of a display of this information to a trader/user in real-time format on a computer display device. FIG. 6 is a Market Map™ (such as disclosed in copending, concurrently-filed U.S. Ser. No. ______ titled “A Graphical User Interface And Method For Displaying Market Data And Entering Trading Orders”, the “Market Map™ application”) showing orders in queue as well as aggregate order quantity. “T1” represents the order first in queue, or the first order that will trade on a time basis. “T2” represents the next order in queue in time (behind the T1 order), and so on for T3 and T4. The “T5+” column represents the aggregate quantity of all orders in the 5^{th} and greater positions in queue. The cells whose borders are lined for yellow and indicated by “Y” represent orders entered by the operating trader.

Still referring to FIG. 6, as explained in the Market Map™ application, a particularly preferred embodiment of the present invention is shown, constituting a two-dimensional GUI map or grid 10, known as “Market Map™” and permitting and facilitating trading operations. Columns 20 and 30, respectively, are stop working order and limit working order columns showing the number of working limit orders and working stop orders, entered by the trader. The limit price or stop price of the order is represented by price column 40, which represents the normal range of prices in the market. The number of displayed prices may be adjusted by simply stretching the size of the display window using normal windows-style controls. In this way, the Market Map™ can be made to show all price levels available for order entry.

As explained above, the columns to the right of the price column represent market volumes. In this embodiment, these represent the aggregate of working orders in the market at the moment. These volumes may be updated in real-time as a price feed is transmitted from the electronic market. The volume range of each column may be adjusted using slider control 50. As slider control 50 is moved to the left, the volume range of each column is decreased, for example; at its left-most position, each column will represent a volume size of 1. At the right-most extreme, the slider control will represent a single column showing all volume in one column. Within each volume column, the total working volume at that price level may be displayed. Offers may be shown with a red background, and bids shown with a green background, for example. In the preferred example, a thick line 60 may be used to separate the two and show the boundary between bids and offers. An individual cell may be highlighted in yellow, for example (“Y”), as shown to indicate that the trader has an order working at that price level within the displayed volume.

Still referring to FIG. 6, bottom row 70 of numbers, below the volume grid, shows the order quantity that will be entered if the trader clicks in that column. The order quantity for each column may be entered by the trader via keyboard; in this manner, the number of order quantities typically used by the trader may be pre-set by the trader.

The Market Map™ embodiment shown in FIG. 6may be used by the trader as follows. First, the trader can view the current market conditions and ascertain which price levels are active in the market and which volumes are active in the market. As prices levels changes, the individual grid cells (e.g., 80) move up or down. As new prices are added, new cells may appear with the appropriate color and volume. Thus, vertical motion of cells may indicate a change in market prices; in other words, vertical movement of highlights cells may show a price movement in the market either upwardly or downwardly. This display provides the trader with an immediate sense of the overall market “depth,” i.e., how many price levels have volume associated with them.

Using the Market Map™, the trader can assess the volume available at each price level. The further the highlighted cell is located to the right, for example, the greater the volume at that price level. This is believed to represent a significant advantage from previous displays that simply show the volume at each level without providing a spatial sense of the volume that can be assessed quickly, visually and without having to interpret individual digits. It will be appreciated that as highlighted cells move left or right (in the Market Map embodiment shown in FIG. 6, the trader can quickly ascertain changes in market volume within specific price levels.

As it should now be appreciated, the trader can quickly enter orders for any price level by clicking within any individual cell. For example, by clicking in the top left cell 80a of FIG. 6, the trader will enter an order at a price of 200250 and a quantity of ______. By clicking in the top right cell 80b, the trader will enter an order at a price of 200250 and quantity of 40. Thus, each cell represents a unique price/quantity combination for order entry. This represents a significant enhancement over existing order-entry systems in that a full range of price/quantity order parameters can be entered with a single click. This represents a savings of one to several clicks which is a significant advantage in fast electronic markets. Clicks entered within the offer zone may be interpreted as offers, while clicks in the bid zone may be interpreted as bids. Additional controls may be provided to allow the trader to override this default behavior, for example (e.g. a “Swipe” button may be used to reverse this convention).

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

I claim:

1. A method for estimating the time position of queued electronic orders, wherein an electronic market distributes price and volume data for the electronic orders using an aggregate volume distribution method, comprising the steps of:
market participants entering a plurality of buy and sell orders at the same price level into an electronic market;
queueing the orders in the order in which they are received into order queue position;
distributing price and volume data for the orders using an aggregate volume distribution method; and
revealing the order queue position to the market participants, applying a worst case order queue position estimate for aggregate volume updates.

2. The method of claim 1, further comprising the step of updating in real time new buy and sell orders, and displaying the updated order queue position to the market participants.

3. A method for estimating the time position of queued electronic orders, wherein an electronic market distributes price and volume data for the electronic orders using an order volume distribution method comprising the steps of:
market participants entering a plurality of buy and sell orders at the same price level into an electronic market;
queueing the orders in the order in which they are received;
distributing price and volume data for the orders using an order volume distribution method; and
revealing the order queue position to the market participants, applying a worst case order queue position estimate for order volume updates.

4. The method of claim 3, further comprising the step of updating in real time new buy and sell orders, and displaying the updated order queue position to the market participants.

5. An electronic trading system allowing market participants to place a trade order for a commodity traded on an electronic market, wherein an electronic market distributes price and volume data for the electronic orders using an aggregate volume distribution method the system comprising:
a display for displaying market depth of the commodity, and for displaying an order entry region aligned with a display of prices for the commodity, the order entry region comprising a plurality of areas for receiving commands to send trade orders, each area corresponding to one of the prices for the commodity;
a user input device for a positioning a pointer thereof over an area in the order entry region; and
the display revealing the order queue position for the commodity to the market participants, and revealing distributed price and volume data for the orders using an aggregate volume distribution method, applying a worst case order queue position estimate for aggregate volume updates.

6. The electronic trading system of claim 5, wherein the trade orders are updated in real time, and the display reveals the updated order queue position and updated distributed price and volume data for the updated orders.

7. An electronic trading system allowing market participants to place a trade order for a commodity traded on an electronic market, wherein an electronic market distributes price and volume data for the electronic orders using an order volume distribution method the system comprising:
a display for displaying market depth of the commodity, and for displaying an order entry region aligned with a display of prices for the commodity, the order entry region comprising a plurality of areas for receiving commands to send trade orders, each area corresponding to one of the prices for the commodity;
a user input device for a positioning a pointer thereof over an area in the order entry region; and
the display revealing the order queue position for the commodity to the market participants, and revealing distributed price and volume data for the orders using a order volume distribution method, applying a worst case order queue position estimate for order volume updates.

8. The electronic trading system of claim 7, wherein the trade orders are updated in real time, and the display reveals the updated order queue position and updated distributed price and volume data for the updated orders.
